(19) United States
(12) Patent Application Publication
(10) Pub. No.: US 2011/0277308 A1
(43) Pub. Date: Nov. 17, 2011

(54) INTEGRATED SECURITY LOCK

(75) Inventor: David A. Gilbert, Prestwich (GB)

(73) Assignee: International Business Machines Corporation, Armonk, NY (US)

(21) Appl. No.: 13/031,523

(22) Filed: Feb. 21, 2011

(30) Foreign Application Priority Data
May 17, 2010 (GB) 10162926.9

(51) Int. Cl. E05B 73/00; H01R 43/00; B23P 11/00; H01R 3/00

(52) U.S. Cl. 29/525.01; 403/42; 29/857

(57) ABSTRACT

A substantially flexible connector, and method of manufacture for a portable electronic device comprising: a lockable attachment mechanism at a first end of said connector for securing the portable electronic device to said connector; a securable attachment mechanism at a second end of said connector for securing said connector to a fixed point; and a power supply connector integrated with said connector. Further, a method of securing a portable electronic device, the method comprising: providing a substantially flexible connector; attaching the lockable attachment mechanism to the portable electronic device; in response to attaching the lockable attachment mechanism, locking the lockable attachment mechanism; and securing the securable attachment mechanism to a fixed point.

### BACKGROUND

Portable electronic devices allow users to access business resources from a wide variety of locations. Examples of portable electronic devices are laptops and video projectors. However, users often need to carry additional equipment to make their portable electronic devices suitable for use when away from their normal work location. For example, although many portable electronic devices comprise an integrated battery, users often also carry a power adapter and its associated cables, because of the limited charge life of batteries.

A portable electronic device can be secured using a lock that is secured to a security slot, and a cable that can be attached to a permanent object. However, only the portable electronic device is secured using this lock and cable, and the lock and cable result in additional weight to carry.

### BRIEF SUMMARY

Viewed from a first aspect, the present invention provides a substantially flexible connector for a portable electronic device comprising: a lockable attachment mechanism at a first end of said connector for securing the portable electronic device to said connector; a securable attachment mechanism at a second end of said connector for securing said connector to a fixed point; and a power supply connector integrated with said connector.

In some embodiments, the present invention provides a connector, wherein: the lockable attachment mechanism comprises a power plug and a locking device; and the securable attachment mechanism comprises: a power adapter coupled to an integrated cable, the integrated cable comprising a security cable and a power adapter cable, wherein the security cable is substantially integrated with the power adapter cable. Advantageously the present invention provides for the integrated cable to be passed through a fixed object, and locked to the portable electronic device. With a fixed object that cannot fit the power adapter, the portable electronic device is secured. Advantageously, the present invention allows users to secure a portable electronic device without having to carry a separate security locking cable and a power adapter unit around. Advantageously, the present invention provides for a shared power adapter to be kept securely in a meeting room so that anyone can charge their laptop during a meeting.

In some embodiments, the present invention provides a connector, further comprising a compartment coupled to the power adapter. Advantageously the present invention provides for the integrated cable to also be passed around or through the fixed object, and the compartment, thus securing the portable electronic device, without having to have a fixed object that the power adapter cannot fit through.

In some embodiments, the present invention provides a connector, wherein the compartment comprises a cable loop. Advantageously the present invention provides for the compartment to be integrated as part of the power adapter casing, or as a flexible extension to the connector.

In some embodiments, the present invention provides a connector, wherein the power plug is integrated into the locking device. Preferably, the present invention provides a connector, further comprising a further locking device for locking the compartment. Advantageously, the present invention allows a shared power adapter to be kept securely in a meeting room so that anyone can charge their laptop during a meeting.

In some embodiments, the present invention provides a connector, wherein the security cable comprises the power adapter cable. Advantageously the present invention provides flexibility and lower cost manufacturing of the integrated cable, as the inner layers of the security cable can comprise the power cable. Advantageously the present invention provides lower cost manufacturing of the power plug and locking device through single manufacturing steps of construction.

Viewed from a second aspect the present invention provides a method of securing a portable electronic device, the method comprising the steps of: providing a substantially flexible connector, comprising: a lockable attachment mechanism at a first end of said connector for securing the portable electronic device to said connector; a securable attachment mechanism at a second end of said connector for securing said connector to a fixed point; and a power supply connector integrated with said connector; attaching the lockable attachment mechanism to the portable electronic device; in response to attaching the lockable attachment mechanism, locking the lockable attachment mechanism; and securing the securable attachment mechanism to a fixed point.

In some embodiments, the present invention provides a method, wherein the step of providing the substantially flexible connector comprises: providing a power adapter coupled to an integrated cable, the integrated cable comprising a security cable and a power adapter cable, wherein the security cable is substantially integrated with the power adapter cable; and providing a power plug and a locking device; the method further comprising the steps of: looping the integrated cable around a stationary object; in response to looping the integrated cable around the stationary object, attaching the locking device to the portable electronic device; in response to attaching the locking device to the portable electronic device, locking the locking device.

In some embodiments, the present invention provides a method, wherein the step of looping the integrated cable around a stationary object further comprises a step of looping the integrated cable through a compartment coupled to the security device.

In some embodiments, the present invention provides a method, wherein the method further comprises the step of locking the further locking device.

Viewed from a third aspect the present invention provides a method of manufacture of a substantially flexible connector, comprising the steps of: providing a lockable attachment mechanism at a first end of said connector for securing a portable electronic device to said connector; providing a securable attachment mechanism at a second end of said connector for securing said connector to a fixed point; and integrating a power supply connector with said connector.

In some embodiments, the present invention provides a method, wherein the step of providing a lockable attachment mechanism comprises providing a power plug and a locking device; and the step of providing a securable attachment mechanism comprises providing a power adapter coupled to an integrated cable, the integrated cable comprising a security cable and a power adapter cable, wherein the security cable is substantially integrated with the power adapter cable.

In some embodiments, the present invention provides a method, wherein the method further comprises the step of providing a compartment coupled to the power adapter. In some embodiments, the present invention provides a method, wherein providing the compartment comprises providing a cable loop. In some embodiments, the present invention provides a method, wherein the method further comprises the step of integrating the power plug with the locking device. In some embodiments, the present invention provides a method, wherein the method further comprises the step of providing a further locking device for locking the compartment.

### BRIEF DESCRIPTION OF THE SEVERAL VIEWS OF THE DRAWINGS

The present invention will now be described, by way of example only, with reference to various embodiments, as illustrated in the following figures:

FIG. 1 is a block diagram depicting a security system for a portable electronic device, in accordance with the prior art;

FIG. 2 is a block diagram depicting a flexible connector for a portable electronic device, in accordance with an embodiment of the present invention;

FIG. 3 depicts a block diagram of a security device, in which an embodiment of the present invention may be implemented;

FIG. 4 depicts a block diagram of the integrated connector, in which an embodiment of the present invention may be implemented;

FIG. 5 is a high-level exemplary schematic flow diagram depicting operation method steps for securing a portable electronic device, in accordance with an embodiment of the present invention;

FIG. 6 is a block diagram depicting the security device before a portable electronic device has been secured, in accordance with an embodiment of the present invention;

FIG. 7 is a block diagram depicting the security device as the portable electronic device is being secured, in accordance with an embodiment of the present invention;

FIG. 8 is a block diagram depicting the security device as the portable electronic device is being secured using a fixed loop for a stationary object, in accordance with an embodiment of the present invention;

FIG. 9 is a further block diagram depicting the security device, in accordance with an alternative embodiment of the present invention; and

FIG. 10 depicts embodiments for a security device and a locking device, in accordance with alternative embodiments of the present invention.

### DETAILED DESCRIPTION

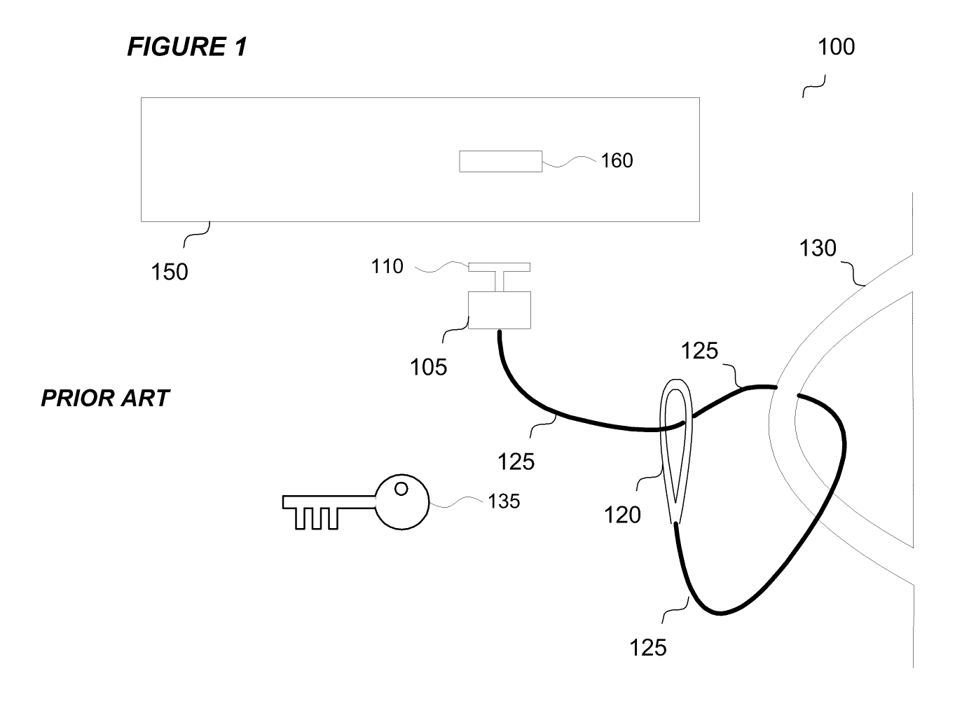

FIG. 1 is a block diagram depicting a security system 100 for a portable electronic device 150, in accordance with the prior art. The portable electronic device 150 comprises a security slot 160, which is a metal-reinforced hole. It is used for attaching a locking device 105 and a security cable 125. The security cable 125 is attached at one end to the locking device 105. The other end of the security cable 125 has a small loop 120 that allows the security cable 125 to be looped around a permanent object 130 securely. The locking device 105 comprises an extension 110 that fits into the security slot 160. Once inserted into the portable electronic device, the extension can be rotated by 90° and locked in the rotated position. Typically, the lock 105 is secured using a key 135, or is a combination lock.

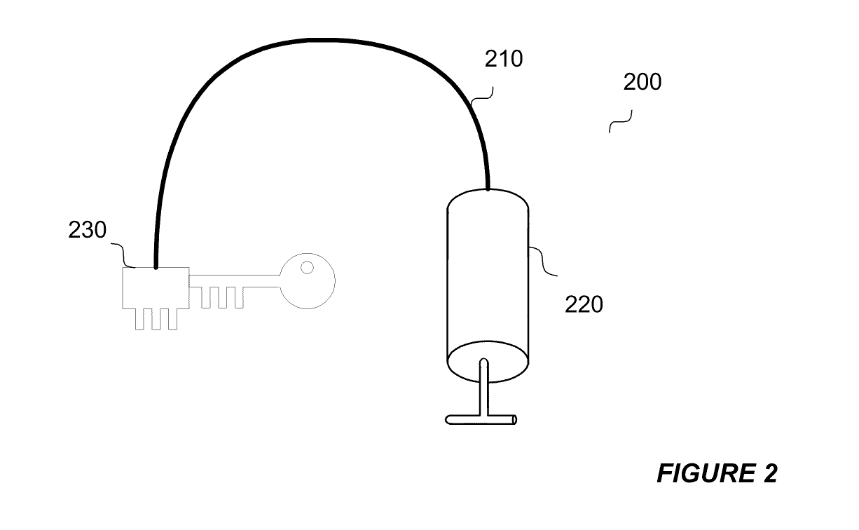

FIG. 2 is a block diagram depicting a flexible connector 200 for a portable electronic device 150, in accordance with an embodiment of the present invention. The flexible connector 200, comprises: a lockable attachment mechanism 220 at a first end of the flexible connector 200 for securing the portable electronic device 150 to the flexible connector 200; an attachment mechanism 230 at a second end of the flexible connector 200 for securing the flexible connector 200 to a fixed point (not shown); and a power supply connector 230 integrated with the flexible connector 200. The section 210 between the two ends is substantially flexible.

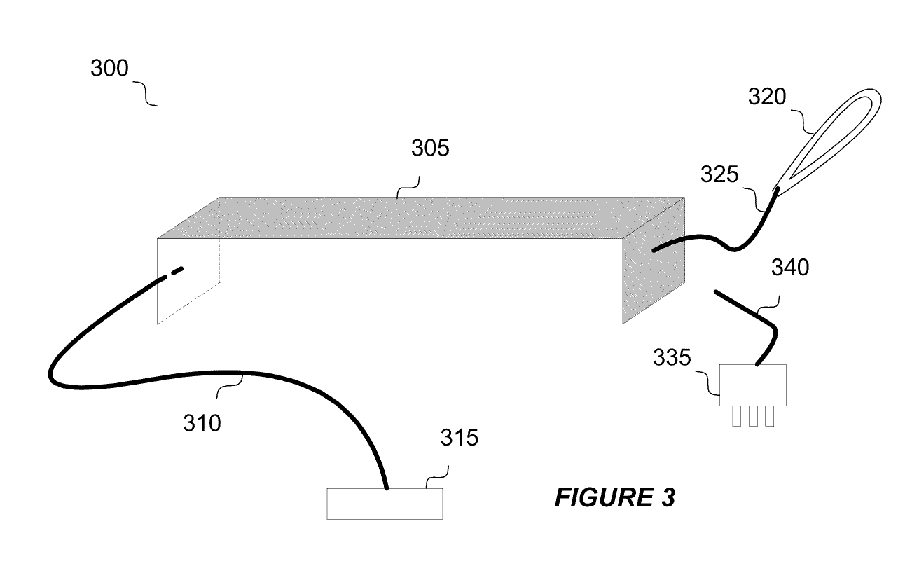

FIG. 3 depicts a block diagram of a security device 300, in which an embodiment of the present invention may be implemented. The security device 300 comprises a power adapter 305 for the portable electronic device 150, an integrated cable 310, an integrated connector 315, a loop cable 325 and a loop 320. The loop 320 is coupled to the loop cable 325. The loop cable 325 is coupled to the power adapter 305. The power adapter 305 is coupled to the integrated cable 310. The integrated cable 310 is coupled to the connector 315. In some embodiments, the case of the power adapter 305 is reinforced so that the path between the loop 320 and the integrated connector 315 is itself strong. In some embodiments, the integrated connector 315 also comprises a plastic housing. In an alternative embodiment, the integrated connector 315 has no housing. A detachable Alternating Current (AC) power cable 340 and AC power plug 335 are connectable to the power adapter 305.

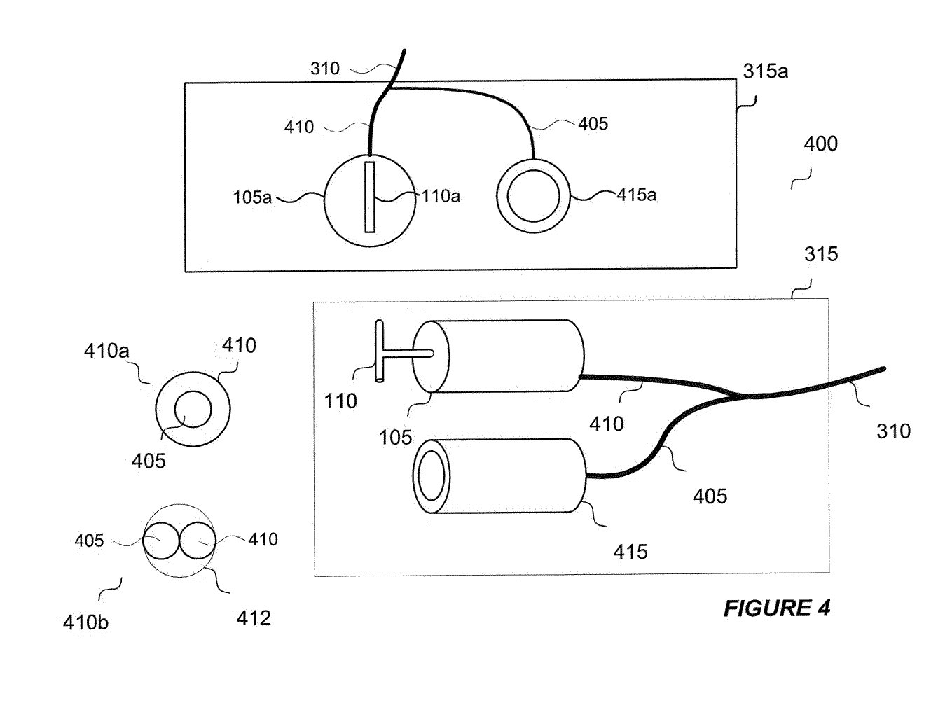

FIG. 4 depicts a block diagram 400 of the integrated connector 315, in which some embodiments of the present invention may be implemented. The integrated connector 315 comprises a power plug 415 connected by a power adapter cable 405 to the integrated cable 310. The integrated connector 315 also comprises a locking device 105 connected by a security cable 410 to the integrated cable 310. The locking device 105 comprises an extension 110. Also depicted is an alternative view 315a of the integrated connector 315, depicting an end on view. The integrated connector 315a comprises a power plug 415a, power adapter cable 405, locking device 105a, security cable 310 and extension 110a.

A number of construction methods may be applied to provide the integrated cable 310. The integrated cable 310 may also comprise different forms. In some embodiments, the integrated cable 310 is in a form 410a comprising the power cable 405 surrounded by the security cable 410. In an alternative embodiment, the integrated cable 310 is in a form 410b comprising the power cable 405 and the security cable 410 surrounded by a further cable 412, which provides further protection.

In some embodiments, the security cable 310, the loop cable 325 and the loop 320 are constructed from a strong material, for example, with steel or with a synthetic fibre such as Kevlar. In some embodiments, the power adapter cable may be constructed from a ferrous cable, surrounded by electromagnetic interference (EMI) protection (for example in the form of a ferrite torus) and insulation. In some embodiments, the integrated cable 210 is surrounded by a polyvinyl chloride (PVC) coating. However, other coating materials could be used.

Variable lengths of cables may be used to construct the integrated cable 310, and the loop cable 325.

In some embodiments, the locking device 105 may be locked or unlocked using a key 135, or by a combination mechanism. However, other locking mechanisms could be used.

In some embodiments, the spacing between the power plug 415 and the locking device 105 is such that by rotating the integrated connector 315 it is possible to ensure that the extension 110 of the locking device 105 does not impinge on a back plate of the portable electronic device 150. Thus the power plug 415 can be inserted in the portable electronic device 150 without having to insert the extension 110. This way, the power adapter 305 can be used without locking the portable electronic device down.

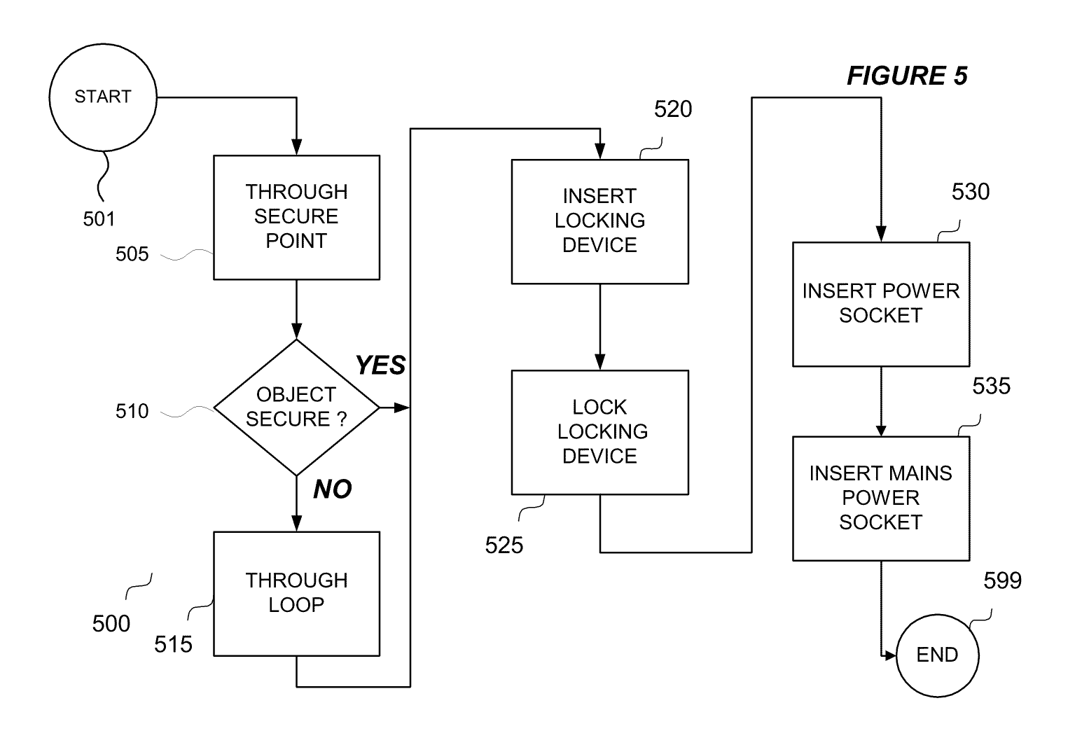

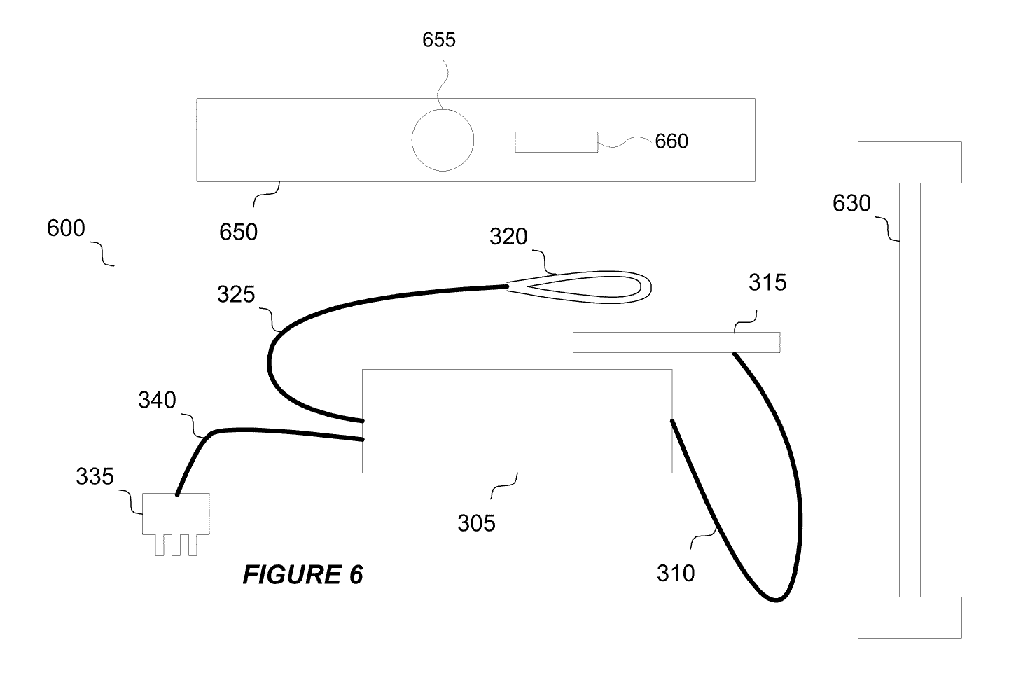

FIG. 5, which should be read in conjunction with FIG. 4, and FIGS. 6-8, is a high-level exemplary schematic flow diagram 500 depicting operation method steps for securing a portable electronic device 650, in accordance with an embodiment of the present invention.

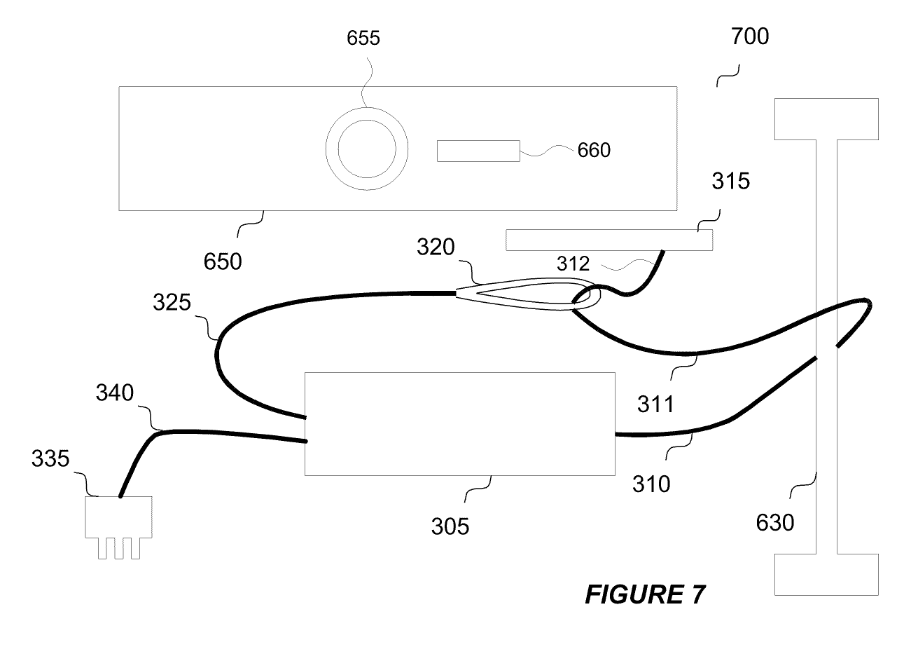

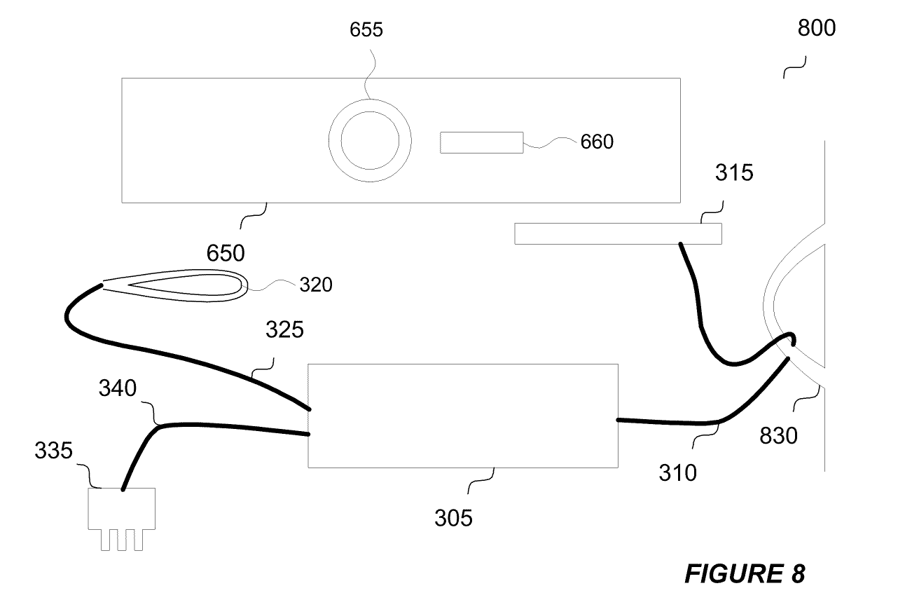

FIG. 6 is a block diagram 600 depicting the security device 300 before the portable electronic device 650 has been secured, in accordance with an embodiment of the present invention. FIG. 7 is a block diagram 700 depicting the security device 300 as the portable electronic device 650 is being secured, in accordance with an embodiment of the present invention. FIG. 8 is a block diagram 800 depicting the security device 300 as the portable electronic device 650 is being secured using a fixed loop 830 for a stationary object 630, 830, in accordance with an embodiment of the present invention.

The method starts at step 501. At step 505 the integrated connector 315 and a portion 311 of the integrated cable 310 are passed through or around a stationary object 630, 830 as depicted in FIGS. 7 and 8. At step 510, a user assesses whether the stationary object 630, 830 is such as to provide sufficient security. If the power adapter 305 can fit through or be removed from the stationary object 630, 830, the stationary object 630, 830 may be such as to not provide sufficient security and therefore step 515 is required. However, if the stationary object 630, 830 is in the form of an item that the power adapter cannot fit through or be removed from, the stationary object 630, 830 does provide sufficient security and therefore step 515 is not required. An example of such a stationary object is the depicted fixed loop in FIG. 8. If the stationary object is such as to provide sufficient security, step 515 is skipped.

At step 515, the integrated connector 315 and a further portion 312 of the integrated cable 310 is passed through the loop 320, as depicted in FIG. 7. At step 520, the locking device 105 is inserted into a security slot 660. At step 525, the extension 110 is rotated in the security slot 660, and the locking device 105 locked. At step 530, the power plug 415 is inserted into a power socket 655 of the portable electronic device 650. At step 535, the AC power plug 335 is connected to a main power socket (not shown). The AC power plug 335 is connected through the AC power cable 340 to the power adapter 305. Therefore, both the portable electronic device 650 and the power adapter 305 are locked to the stationary location 630, 830. The method ends at step 599. A detachable Alternating Current (AC) power cable 340 and AC power plug 335 are connectable to the power adapter 305.

FIG. 5 is set forth as a logical flow chart diagram. As such, the depicted order and labelled steps are indicative of one embodiment of the presented method. Other steps and methods may be conceived that are equivalent in function, logic, or effect of one or more steps or portions thereof, of the illustrated method. Additionally the format and symbols employed are provided to explain the logical steps of the method and are understood not to limit the scope of the method.

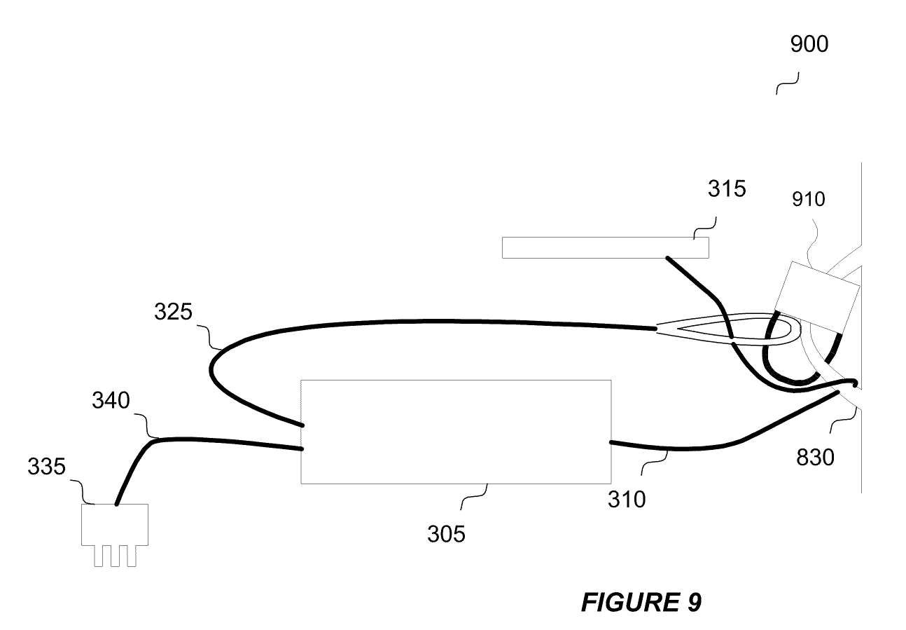

FIG. 9 is a further block diagram 900 depicting the security device, in accordance with an alternative embodiment of the present invention. Once the integrated connector 315 and a portion of the integrated cable 310 are passed through the loop 320, a further lock 910 is used to secure the loop 320 to some fixed point 830. In an alternative embodiment, the further lock 910 can be used to secure the integrated connector 315 within the loop 320. In this way, a shared power adapter can be kept in a meeting room so that anyone can charge their laptop during a meeting. In such a situation, the locking point at the end of the cable might be covered up to prevent people accidentally locking their device to the meeting room, where the key might be centrally held.

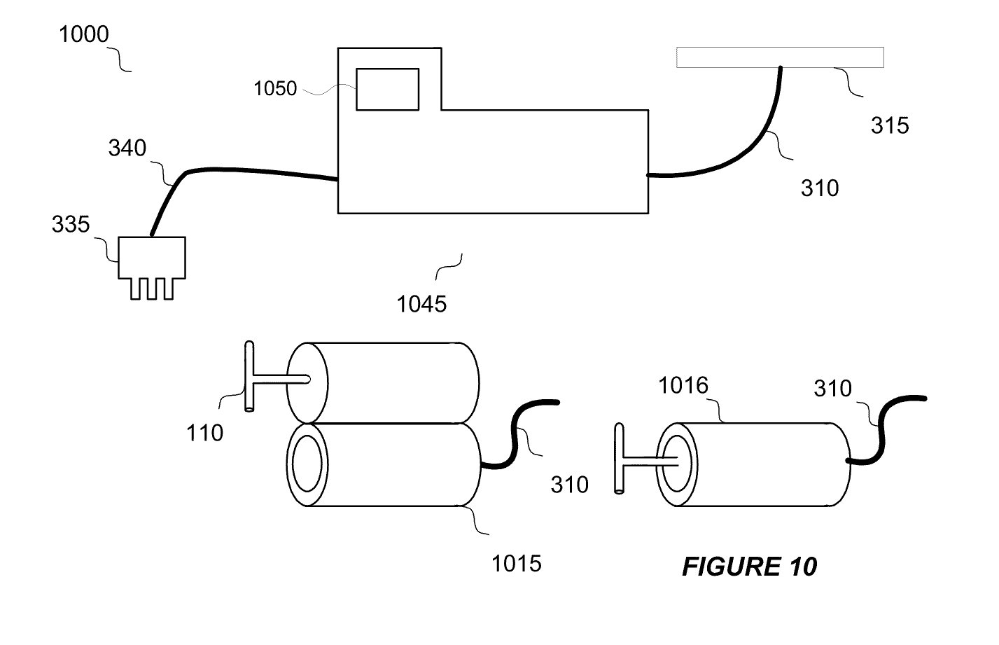

FIG. 10 depicts embodiments 1000 for a security device 1045 and locking devices 1015, 1016, in accordance with an alternative embodiment of the present invention. In the alternative embodiment, the loop 320 and loop cable 325 are replaced by an alternative construction that provides an enclosed loop 1050 that the integrated connector 315 and the integrated cable 310 can be passed to during the method of securing the portable electronic device 650. In an alternative embodiment, the enclosed loop 1050 is part of the power adapter 305. In an alternative embodiment, the power plug 415 and locking device 105 are part of an integrated component 1015. In this case, the power cable 405 and security cable 410 remain integrated throughout their length. In an alternative embodiment, the power plug 415 and the locking device 105 are provided in a fully integrated locking/power device 1016. In this case, the power cable 405 and security cable 410 also remain integrated throughout their length.

For the avoidance of doubt, the term “comprising”, as used herein throughout the description and claims is not to be construed as meaning “consisting only of”.

1. A substantially flexible connector for a portable electronic device comprising:
a lockable attachment mechanism at a first end of said connector for securing the portable electronic device to said connector;
a securable attachment mechanism at a second end of said connector for securing said connector to a fixed point; and
a power supply connector integrated with said connector.

2. The connector of claim 1, wherein:
the lockable attachment mechanism comprises a power plug and a locking device; and
the securable attachment mechanism comprises:
a power adapter coupled to an integrated cable, the integrated cable comprising a security cable and a power adapter cable, wherein the security cable is substantially integrated with the power adapter cable.

3. The connector of claim 2, further comprising a compartment coupled to the power adapter.

4. The connector of claim 3, wherein the compartment comprises a cable loop.

5. The connector of claim 2, wherein the power plug is integrated into the locking device.

6. The connector of claim 3, further comprising a further locking device for locking the compartment.

7. The connector of claim 2, wherein the security cable comprises the power adapter cable.

8. A method of securing a portable electronic device, the method comprising:
providing a substantially flexible connector, comprising:
a lockable attachment mechanism at a first end of said connector for securing the portable electronic device to said connector;
a securable attachment mechanism at a second end of said connector for securing said connector to a fixed point; and
a power supply connector integrated with said connector;
attaching the lockable attachment mechanism to the portable electronic device;
in response to attaching the lockable attachment mechanism, locking the lockable attachment mechanism; and
securing the securable attachment mechanism to a fixed point.

9. The method of claim 8, wherein providing the substantially flexible connector comprises:
providing a power adapter coupled to an integrated cable, the integrated cable comprising a security cable and a power adapter cable, wherein the security cable is substantially integrated with the power adapter cable; and
providing a power plug and a locking device;
the method further comprising:
looping the integrated cable around a stationary object;
in response to looping the integrated cable around the stationary object, attaching the locking device to the portable electronic device; and
in response to attaching the locking device to the portable electronic device, locking the locking device.

10. The method of claim 9, wherein looping the integrated cable around a stationary object further comprises a step of looping the integrated cable through a compartment coupled to the security device.

11. The method of claim 10, wherein the method further comprises locking the compartment with a further locking device.

12. A method of manufacture of a substantially flexible connector, comprising:
providing a lockable attachment mechanism at a first end of said connector for securing a portable electronic device to said connector;
providing a securable attachment mechanism at a second end of said connector for securing said connector to a fixed point; and
integrating a power supply connector with said connector.

13. The method of manufacture of claim 12, wherein providing a lockable attachment mechanism comprises providing a power plug and a locking device; and
providing a securable attachment mechanism comprises providing a power adapter coupled to an integrated cable, the integrated cable comprising a security cable and a power adapter cable, wherein the security cable is substantially integrated with the power adapter cable.

14. The method of manufacture of claim 13, wherein the method further comprises providing a compartment coupled to the power adapter.

15. The method of manufacture of claim 14, wherein providing the compartment comprises providing a cable loop.

16. The method of manufacture of claim 13, wherein the method further comprises integrating the power plug with the locking device.

17. The method of manufacture of claim 14, wherein the method further comprises providing a further locking device for locking the compartment.

18. The connector of claim 4, wherein the power plug is integrated into the locking device.

19. The connector of claim 4, wherein the security cable comprises the power adapter cable.

20. The connector of claim 5, wherein the security cable comprises the power adapter cable.

21. The connector of claim 6, wherein the security cable comprises the power adapter cable.

22. The method of manufacture of claim 15, wherein the method further comprises integrating the power plug with the locking device.

23. The method of manufacture of claim 15, wherein the method further comprises providing a further locking device for locking the compartment.
